(19) United States
(12) Patent Application Publication
(10) Pub. No.: US 2022/0176795 A1
(43) Pub. Date: Jun. 9, 2022

(54) Powertrain for a Motor Vehicle, and Method for Operating a Powertrain

(71) Applicant: ZF Friedrichshafen AG, Friedrichshafen (DE)

(72) Inventors: Stefan Beck, Eriskirch (DE); Matthias Horn, Tettnang (DE); Thomas Martin, Weissensberg (DE); Fabian Kutter, Kressbronn (DE); Johannes Kaltenbach, Friedrichshafen (DE); Peter Ziemer, Tettnang (DE); Martin Brehmer, Tettnang (DE); Oliver Bayer, Hörbranz (AT); Thomas Kroh, Lindau (DE); Michael Wechs, Weißensberg (DE); Max Bachmann, Friedrichshafen (DE)

(21) Appl. No.: 17/435,888

(22) PCT Filed: Oct. 15, 2019
(86) PCT No.: PCT/EP2019/077946

§ 371 Date: Sep. 2, 2021

(30) Foreign Application Priority Data
Mar. 5, 2019 (DE) 10 2019 202 964.7

(51) Int. Cl. B60K 6/387; F16H 61/28; F16H 63/08; B60K 6/36; B60K 6/442; B60K 6/547; F16H 3/091; F16H 61/688

(52) U.S. Cl. CPC B60K 6/387; F16H 61/28; F16H 63/08; B60K 6/36; B60K 6/442; F16H 2063/025; F16H 3/091; F16H 61/688; F16H 2200/0047; F16H 2200/0069; B60Y 2200/92; B60K 6/547

(57) ABSTRACT

A drive train (10) for a motor vehicle includes a dual-clutch assembly (14) with a first clutch (K1) and a second clutch (K2), which include a shared input element (EG). The dual-clutch assembly (14) is connectable to an internal combustion engine (12). The first clutch (K1) includes a first output element (AG1), and the second clutch (K2) includes a second output element (AG2). A first actuating unit (S1) is associated with the first clutch (K1), and a second actuating unit (S2) is associated with the second clutch (K2). A transmission arrangement (16) includes a first sub-transmission (32) and a second sub-transmission (34). An input shaft (24) of the first sub-transmission (32) is connected to the first output element (AG1), and an input shaft (26) of the second sub-transmission (34) is connected to the second output element (AG2). The second actuating unit (S2) is associated with the second clutch (K2) of the dual-clutch assembly (14) as well as with a gearshift clutch (C; E) of the first sub-transmission (32), and/or the first actuating unit (S1″) is associated with the first clutch (K1) of the dual-clutch assembly (14) as well as with a gearshift clutch (F) of the second sub-transmission (34).

### CROSS-REFERENCE TO RELATED APPLICATIONS

The present application is related and has right of priority to German Patent Application No. 102019202964.7 filed in the German Patent Office on Mar. 5, 2019 and is a nationalization of PCT/EP2019/077946 filed in the European Patent Office on Oct. 15, 2019, both of which are incorporated by reference in their entirety for all purposes.

### FIELD OF THE INVENTION

The present invention relates generally to a drive train for a motor vehicle, with a dual-clutch assembly, which has a first clutch and a second clutch, which include a shared input element, which is connectable to an internal combustion engine. The first clutch includes a first output element, and the second clutch includes a second output element. A first actuating unit is associated with the first clutch, and a second actuating unit is associated with the second clutch. with the drive train also includes a transmission arrangement, which includes a first sub-transmission and a second sub-transmission. An input shaft of the first sub-transmission is connected to the first output element, and an input shaft of the second sub-transmission is connected to the second output element.

The present invention further relates generally to a method for operating a drive train of this type.

### BACKGROUND

A transmission arrangement of the above-described type is known from document DE 10 2006 036 758 A1. The automated dual clutch transmission disclosed therein includes two input shafts and at least one output shaft and an unsynchronized gear clutch, wherein associated with each of the input shafts is a separate motor/engine clutch for connection to the drive shaft of a prime mover and, for connection to the output shaft, a group of gear-step gearwheels, in each case, having different ratios and each including one fixed gear and one idler gear engageable by an associated gear clutch. In order to simplify the configuration and the controllability, the two engine clutches are designed as unsynchronized dog clutches. Two electric machines, which are alternately drivingly connected to one of the input shafts, are provided as starting and synchronizing means.

Dual clutch transmissions have represented an alternative to torque converter automatic transmissions for several years. Dual clutch transmissions have a dual-clutch assembly, which is connectable on the input side to a prime mover, such as an internal combustion engine. An output element of a first friction clutch of the clutch assembly is connected to a first input shaft of a first sub-transmission, which is typically associated with the even forward gear steps or with the odd forward gear steps. An output element of a second friction clutch of the dual-clutch assembly is connected to a second input shaft of a second sub-transmission, which is typically associated with the other forward gear steps.

The gear steps associated with the sub-transmissions can generally be engaged and disengaged in an automated manner. During normal operation, one of the clutches of the dual-clutch assembly is engaged. In the other, inactive, sub-transmission, a connecting gear step can then be engaged in advance. A gear change can then be carried out essentially without interruption of tractive force by an overlapping actuation of the two friction clutches.

Motor vehicle transmissions are generally designed either for the front or the rear transverse installation in a motor vehicle, wherein attention is paid, in particular, to a short axial installation length. Alternatively, transmissions are designed for a longitudinal installation in a motor vehicle, wherein attention is paid, in particular, to a radially compact design.

In the front-mounted and rear-mounted transverse transmissions, two countershafts arranged axially parallel are frequently associated with an input shaft arrangement, and so the power flow can take place from the input shaft arrangement either via the one countershaft or via the other countershaft. The countershafts are also designed as output shafts and, in general, are both in engagement with a differential for distributing input power to driven wheels.

A further trend in the field of motor vehicle drive trains is hybridization. In general, this means a prime mover in the form of an internal combustion engine has associated therewith an electric machine, as a further prime mover. Here, a distinction is made between a plurality of different concepts, which each provide a different connection of the electric machine to the transmission. In a typical variant of dual clutch transmissions, an electric machine is arranged concentrically to an input element of the dual-clutch assembly. In order to be able to utilize the electric machine, in this case, not only for assisting the internal combustion engine, but rather also to be able to set up a purely electric motor-driven operation, the input element of the dual-clutch assembly is generally connected to the internal combustion engine by a separating clutch or an internal combustion engine-decoupling device.

The hybridization of transmissions, with respect to the requirements mentioned at the outset, places high requirements on radial and/or axial installation space.

In the dual clutch transmission described in DE 10 2006 036 758 A1 mentioned at the outset, an electric machine is associated with each sub-transmission. Moreover, the dual-clutch assembly is formed by two unsynchronized dog clutches. The rotational-speed adaptations necessary for the starting operation and for the synchronization during gear changes are implemented by the electric machines. The unsynchronized dog clutches are combined in a shared clutch block, which has two engagement positions, in which one of the two clutches is engaged in each case, and a neutral position with a completely interrupted power flow. During gear changes in an internal combustion engine-driven operation, a changeover of the clutches of the dual-clutch assembly is always necessary. Moreover, depending on the type of the gear change, one or both electric machine(s) must be actuated for the synchronization and/or for the load transfer. Moreover, during these types of gear changes, the internal combustion engine must always self-synchronize. Moreover, the dual-clutch transmission known from this prior art needs a comparatively high number of actuating units.

### SUMMARY OF THE INVENTION

Example aspects of the present invention provide an improved drive train for a motor vehicle and improved methods for operating a drive train of this type.

Example aspects of the present invention provide, on the one hand, by a drive train for a motor vehicle with a dual-clutch assembly. The dual clutch assembly has a first clutch and a second clutch, which include a shared input element. The dual clutch assembly is connectable to an internal combustion engine. The first clutch includes a first output element, and the second clutch includes a second output element. A first actuating unit is associated with the first clutch, and a second actuating unit is associated with the second clutch. The drive train also includes a transmission arrangement, which includes a first sub-transmission and a second sub-transmission. An input shaft of the first sub-transmission is connected to the first output element, and an input shaft of the second sub-transmission is connected to the second output element. The second actuating unit is associated with the second clutch of the dual-clutch assembly as well as with a gearshift clutch of the first sub-transmission, and/or the first actuating unit is associated with the first clutch of the dual-clutch assembly as well as with a gearshift clutch of the second sub-transmission.

Moreover, example aspects of the present invention provide a method for operating a drive train of the type according to example aspects of the invention, includes, starting from a condition, in which (i) the first clutch or the second clutch is engaged, in which (ii) the other clutch is disengaged, and in which (iii) input power is transmitted via the engaged clutch: disengaging all gearshift clutches of the sub-transmission associated with the other clutch, if necessary; synchronizing the rotational speed of the input shaft associated with the other clutch with the electric machine associated with the other clutch; and engaging the other clutch.

Moreover, example aspects of the present invention provide a method for operating a drive train of the type according to example aspects of the invention, includes, in a purely electric motor-driven operation, providing input power of the first electric machine via the first sub-transmission and simultaneously providing input power of the second electric machine via the second sub-transmission, and implementing a powershift, in that one of the electric machines maintains the tractive force via the associated sub-transmission, while a gear change is carried out in the other sub-transmission.

Due to the measure of associating a clutch of the dual-clutch assembly as well as a gearshift clutch of a sub-transmission with at least one actuating unit of the two actuating units, the number of actuating units necessary for actuating the drive train can be reduced. Installation space/weight can be saved as a result. An actuating unit is understood, in the present case, to be, in particular, a unit of the type that is capable of applying an actuation force in a first axial direction and in an opposite, second axial direction, in order to actuate a clutch of the drive train. In general, it is conceivable that the actuating unit is manually actuated. It is particularly preferred, however, when the actuating unit also includes at least one actuator, which is capable of generating the aforementioned actuation forces. The actuator of the actuating unit can be an electric motor-operated actuator, a hydraulic actuator, an electro-hydraulic actuator, or an electromagnetic actuator, in order to name a few examples.

An actuating unit preferably includes an element, such as, for example, a shift rail, which is axially displaceable within a housing of the drive train. The axially displaceable element is preferably axially displaceable in the two opposite directions by the associated actuator. The axially displaceable element is preferably coupled to the associated clutch of the dual-clutch assembly, as well as to the associated gearshift clutch. For this purpose, the axially displaceable element can include, for example, selector forks or swing forks, which engage into associated synchronizer sleeves of the clutch of the dual-clutch assembly and of the gearshift clutch of the sub-transmission.

An association of an actuating unit with a clutch of the dual-clutch assembly and with a gearshift clutch can be understood to mean that these clutches are necessarily simultaneously engaged. Preferably, the association is implemented in such a way, however, that the clutches are alternately engaged, wherein a neutral position is also preferably implemented, in which neither of these two clutches is engaged or both are disengaged.

In the transmission arrangement, the first input shaft and the second input shaft are preferably arranged coaxially to each other. The first input shaft is preferably designed as an inner shaft. The second input shaft is preferably designed as a hollow shaft. The transmission arrangement preferably includes precisely one countershaft. Preferably, the one countershaft is simultaneously an output shaft of the transmission arrangement. For this purpose, the countershaft is preferably connected to an output gear, which is designed for driving a power distribution arrangement, such as a differential.

Engageable gear sets are understood to be, in the present case, gear sets that include an idler gear and a fixed gear, which are in engagement with each other in an intermeshed manner, and which are engageable by an associated gearshift clutch. In an engaged gear set, the idler gear of this gear set is rotationally fixed to the associated shaft. The gear sets are preferably spur gear trains, which preferably connect one of the two input shafts and the countershaft to each other, in each case.

Associated with each gear set, preferably, is a regular forward gear step, i.e., a fixed ratio. The transmission arrangement preferably does not include a gear set, with which a reverse gear step is associated. Travel in reverse is preferably implemented exclusively via an electric machine.

In one preferred example embodiment, the first sub-transmission is associated with the odd gear steps. In a corresponding way, the second sub-transmission in one preferred example embodiment is associated with the even forward gear steps.

In the present case, a connection is understood to mean, in particular, that the two elements to be connected to each other are permanently connected to each other in a rotationally fixed manner. Alternatively or as necessary, the two elements can be connected to each other in a rotationally fixed manner. In the present case, a rotationally fixed connection is understood to mean that the elements connected in this way rotate at a rotational speed proportional to each other.

In a preferred example variant, the order of the elements starting from an input of the transmission arrangement is as follows: gear set for the fourth forward gear step 4, gearshift clutch assembly for the fourth and second forward gear steps 4 and 2, gear set for the second forward gear step 2, gearshift clutch for the third forward gear step 3 (or the fifth forward gear step 5), gear set for the third forward gear step 3 (or the fifth forward gear step 5), gear set for the first forward gear step 1, gearshift clutch assembly for the first and fifth forward gear steps 1 and 5 (or the first and third forward gear steps 1 and 3), and gear set for the fifth forward gear step 5 (or the third forward gear step 3).

The gearshift clutch assemblies for the second and fourth forward gear steps 2 and 4 as well as the first and fifth forward gear steps 1 and 5 (or the first and third forward gear steps 1 and 3) are preferably arranged at a countershaft. A gearshift clutch for the third forward gear step 3 (or the fifth forward gear step 5) is preferably arranged coaxially to the input shafts.

In an alternative example embodiment, a gear set for a sixth forward gear step 6 is arranged between the gear set for the second forward gear step 2 and the gearshift clutch for the third forward gear step 3 (or the fifth forward gear step 5). In this case, it is preferred when a gearshift clutch for the sixth forward gear step 6 is arranged at the countershaft and, in fact, in a gearshift clutch plane, and/or aligned with the gearshift clutch for the third forward gear step 3 (or the fifth forward gear step 5).

In a preferred example variant, the second actuating unit is associated with the second clutch of the dual-clutch assembly as well as with the gearshift clutch of the first sub-transmission that is arranged at the first input shaft for engaging the third forward gear step 3 (or the fifth forward gear step 5).

Moreover, in the preferred example embodiment, instead thereof or in addition thereto, the first clutch of the dual-clutch assembly can be coupled to the gearshift clutch of the second sub-transmission that is associated with the forward gear step 6.

In general, a gearshift clutch assembly is understood to be an arrangement formed from two gearshift clutches, which are alternately actuatable by one single actuating unit. Moreover, a gearshift clutch assembly generally has a neutral position, in which neither of the two gearshift clutches of the assembly is engaged. A gearshift clutch assembly of this type can also be referred to as a double shift element. Preferably, the clutch of the dual-clutch assembly and the gearshift clutch, which are actuatable by a shared actuating unit, functionally form this type of gearshift clutch assembly, even though the clutches are arranged spatially separated from each other.

In a preferred example embodiment, the drive train includes a first electric machine, which is connected to the first input shaft, and/or a second electric machine, which is connected to the second input shaft.

Here, a control device of the drive train can be configured for establishing at least the following operating modes: a purely internal combustion engine-driven operation; a purely electric operation by the first electric machine; and a purely electric operation by the second electric machine.

Moreover, the control device is preferably configured for establishing a hybrid operation, in which input power is provided by the internal combustion engine and electric motor-generated input power is provided by the first electric machine and/or the second electric machine. The hybrid traveling mode can be a drive mode, although the hybrid traveling mode can also be a mode, in which mechanical input power is at least partially supplied to the electric machines, in order to operate the electric machines as generators for charging a vehicle battery.

The drive train, which is designed as a hybrid drive train in this case, is preferably configured, moreover, for carrying out a sailing operation, in which, starting from a moderate or high ground speed, the internal combustion engine is decoupled and the ground speed is maintained, for example, by an intermittent operation of one or both electric machine(s). Stationary charging is also possible. In general, this type of hybrid drive train is therefore operable in all conceivable electric motor-driven, internal combustion engine-driven, or hybrid traveling modes.

A crawling mode is also possible, in particular for the case in which a serial operation is established.

In the present case, a serial operation is understood to mean that, in a purely electric motor-driven operation by one of the two electric machines, the other electric machine is simultaneously driven by the internal combustion engine and operated as a generator, in order to charge a vehicle battery. The vehicle battery is preferably the same battery from which the electric machine operating as a motor withdraws power.

In the serial operation, one electric machine therefore operates as a motor and provides electric motor-generated power for a purely electric motor-driven operation, for example, for an operation in a starting gear step (first gear), in order to drive a vehicle in a “crawler gear”. In a crawler gear of this type, the ground speed of the vehicle is generally below a speed, at which the internal combustion engine can be utilized as a prime mover (due to the ratio of the lowest gear step or starting gear step). In order to also be able to permanently establish a low ground speed of this type beyond the maximum capacity of the vehicle battery, the above-described serial operation can be implemented.

In addition, with the hybrid drive train, it is possible to utilize an electric machine for synchronization at least during some gear changes in an internal combustion engine-driven operation or a hybrid operation, i.e., to assist the internal combustion engine during synchronization with an electric machine. In other words, in the internal combustion engine-driven operation or in the hybrid operation, one of the electric machines is always connected to the internal combustion engine. As a result, a load-point displacement at the internal combustion engine is possible and this electric machine can assist during the closed-loop control of the rotational speed when a shift element, such as a gearshift clutch, must be synchronized. Consequently, the internal combustion engine does not need to synchronize “on its own”, but rather is always “picked up” at its current rotational speed by one of the two electric machines.

With respect to the hybrid drive train discussed above, it is preferred when both electric machines are operable as a generator or as a motor.

The electric machines are preferably arranged axially parallel to the transmission arrangement. Consequently, the longitudinal axes of the electric machines are preferably arranged in parallel, although offset with respect to the input shafts as well as to the countershaft.

According to one further preferred example embodiment, the first clutch of the dual-clutch assembly and/or the second clutch of the dual-clutch assembly and/or at least one gearshift clutch of the transmission arrangement are/is designed as a dog clutch, i.e., as a non-synchronized shift element. A dog clutch of this type includes, in particular, no friction elements for synchronizing components to be connected to each another.

Due to the fact that a separate electric machine is preferably associated with each sub-transmission, functions of the synchronization and/or of the load transfer can take place by the electric machines. Accordingly, the above-mentioned clutches can be designed as dog clutches, and so potential for the reduction of the axial and/or radial installation space can result, as well as weight advantages.

In an example embodiment preferred overall, the first electric machine is connected to the first input shaft via a gear-step gear set of the first sub-transmission and/or the second electric machine is connected to the second input shaft via a gear-step gear set of the second sub-transmission.

In general, it is conceivable to arrange the electric machines coaxially to the particular input shaft of the sub-transmissions. It is preferred, however, when the electric machines are arranged axially parallel to the input shaft arrangement. The connection to the particular input shaft can then take place via a flexible traction drive mechanism or a gear set. A separate gear set can be provided for this purpose. This can have the advantage of a connection having an optimized ratio. As mentioned above, it is preferred, however, when the connection of the electric machines takes place via particular gear-step gear sets. Weight can be saved as a result. A ratio adaptation can preferably take place in that a machine pinion of the particular electric machine is not directly connected to a gearwheel of the gear-step gear set or is in engagement therewith in an intermeshed manner, but rather that an intermediate gear is intermediately connected, and so the electric machines can be connected to the particular sub-transmissions with an optimized ratio. In particular, the electric machines can be implemented as relatively high-speed machines, which, consequently, can be designed to be compact.

It is particularly preferred when the gear-step gear set of the first sub-transmission, via which the first electric machine is connected to the first input shaft, is associated with the highest gear step of the first sub-transmission, and/or when the gear-step gear set of the second sub-transmission, via which the second electric machine is connected to the second input shaft, is associated with the highest gear step of the second sub-transmission.

According to one further preferred example embodiment, the gear-step gear set of the first sub-transmission, via which the first electric machine is connected to the first input shaft, is arranged at a first axial end of the transmission arrangement, and/or the gear-step gear set of the second sub-transmission, via which the second electric machine is connected to the second input shaft, is arranged at a second axial end of the transmission arrangement.

This allows for a connection of the electric machine, on the one hand, at the points, at which high bearing forces can be absorbed, since housing walls or bearing plates are generally arranged at the axial ends of the transmission arrangement. Moreover, this allows for a connection of the electric machines in such a way that the electric machines remain as unaffected as possible from each other. In addition, this type of connection makes it possible for the electric machines to be arranged in axial overlap with each other. It is particularly preferred when the first electric machine and/or the second electric machine extend(s) between the first axial end of the transmission arrangement and the second axial end of the transmission arrangement. As a result, an axially compact design can also be implemented.

According to one further example embodiment preferred overall, the first sub-transmission is associated with the odd forward gear steps and includes three gear sets, which are associated with different forward gear steps, and/or the second sub-transmission is preferably associated with the even forward gear steps and includes two or three gear sets, which are associated with different forward gear steps.

With five or six forward gear steps, an internal combustion engine-driven operation across a large speed range can be implemented. For very low speed ranges, travel can take place exclusively by electric motor, if necessary.

The transmission arrangement therefore preferably has only five or six gear set planes. Moreover, the transmission arrangement preferably has only three gearshift clutch planes, in each of which preferably precisely one gearshift clutch or one gearshift clutch assembly is arranged.

Preferably, the transmission arrangement includes only precisely four actuating units, of which two are associated with the gearshift clutch assemblies of the transmission arrangement and of which one is associated with a clutch of the dual-clutch assembly and of which one is associated with another clutch of the dual-clutch assembly and with a gearshift clutch of the transmission arrangement. Alternatively, it is preferred when, of the precisely four actuating units, two are associated with the gearshift clutch assemblies of the transmission arrangement, one is associated with a clutch of the dual-clutch assembly and with a gearshift clutch of the transmission arrangement, and a further actuating unit is associated with the other clutch of the dual-clutch assembly and with another gearshift clutch of the transmission arrangement.

According to one further example embodiment preferred overall, the first electric machine and the second electric machine are identical.

This yields cost advantages and stock-control advantages. The two electric machines can then operate practically “equally” within the transmission arrangement and can both be operated alternately as a prime mover for driving a motor vehicle and/or as a generator for charging a vehicle battery.

Overall, it is preferred when a coupling of the actuating unit to the clutch of the dual-clutch assembly as well as to the gearshift clutch of the sub-transmission is implemented in such a way that these clutches are alternately engaged or a neutral position is established, in which both clutches are disengaged.

It is understood that the jointly actuated clutches (clutch of the dual-clutch assembly and the gearshift clutch) are associated with different sub-transmissions.

Overall, via the drive train, depending on the example embodiment, at least one of the following advantages is achieved:
low design complexity, since preferably only five (if necessary, six) gear set pairs and four actuating units are to be provided;
good efficiency and a simple configuration result, since, in particular, no winding-path gear steps are implemented;
low component loads result;
at least three electric gear steps result for the first electric machine and at least two gear steps result for the second electric machine;
the transmission arrangement includes preferably only one countershaft, which is preferably connected to a power distribution unit via only one output gear set;
gear change operations can be carried out quickly and efficiently, since the synchronization of gear steps is always implementable also by utilizing an electric machine;
a serial operation is implementable by the first electric machine and also by the second electric machine as a generator; and
high versatility is achieved in combination with compact dimensions.

In the method according to example aspects of the invention for operating a drive train, in which a synchronization of the rotational speed of the input shaft associated with the other clutch takes place by the electric machine associated with the other clutch, it is preferred when, after the engagement of the other clutch, the initially engaged clutch is disengaged and, thereafter, a gearshift clutch in the sub-transmission associated with the other clutch is engaged, wherein the engagement of the gearshift clutch is assisted by the electric machine associated with the initially closed clutch and/or wherein, before the engagement of the gearshift clutch, the gearshift clutch is synchronized by the electric machine associated with the other clutch.

It is understood that the features, which are mentioned above and which will be described in greater detail in the following, are usable not only in the particular combination indicated, but also in other combinations or alone, without departing from the scope of the present invention.

### BRIEF DESCRIPTION OF THE DRAWINGS

Exemplary embodiments of the invention are represented in the drawings and are explained in greater detail in the following description, wherein:

FIG. 1 shows a diagrammatic gear set representation of an example embodiment of a hybrid drive train;

FIG. 2 shows a gearshift table for an internal combustion engine-driven operation and a hybrid operation of the hybrid drive train from FIG. 1;

FIG. 3 shows a gearshift table for an electric motor-driven operation by the first electric machine; and

FIG. 4 shows a gearshift table for an electric motor-driven operation by the second electric machine;

FIG. 5 shows a schematic of a further example embodiment of a hybrid drive train; and

FIG. 6 shows a schematic of a further example embodiment of a hybrid drive train.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

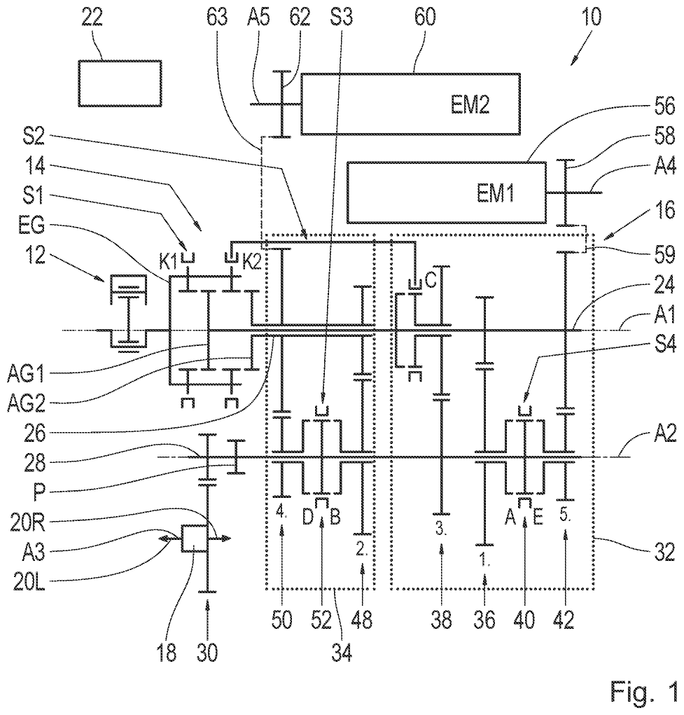

In FIG. 1, a hybrid drive train for a motor vehicle, in particular a passenger car, is represented in diagrammatic form and is labeled, in general, with 10. The hybrid drive train 10 includes an internal combustion engine 12, which is connected to an input element of a dual-clutch assembly 14. The dual-clutch assembly 14 is connected on the output side to a hybrid transmission arrangement 16. An output of the hybrid transmission arrangement 16 is connected to a power distribution unit 18, which can be designed, for example, as a mechanical differential and can distribute the input power to two driven wheels 20L, 20R of the motor vehicle.

Moreover, the hybrid drive train 10 includes a control device 22 for controlling all components thereof.

The dual-clutch assembly 14 is arranged on an axis A1, which is coaxial to a crankshaft of the internal combustion engine 12. The dual-clutch assembly 14 can include two friction clutches or one friction clutch and a non-synchronized dog clutch. In the present case, the dual-clutch assembly 14 contains two non-synchronized dog clutches K1 and K2. The two clutches K1, K2 have a shared input element EG, which is rotationally fixed to the crankshaft of the internal combustion engine 12. The first clutch K1 has a first output element AG1. The second clutch K2 has a second output element AG2. The output elements AG1, AG2 are arranged coaxially to each other.

The transmission arrangement 16 includes a first input shaft 24 and a second input shaft 26. The input shafts 24, 26 are arranged coaxially to each other and to the axis A1. The first input shaft 24 is designed as an inner shaft. The second input shaft 26 is designed as a hollow shaft.

Moreover, the transmission arrangement 16 includes a countershaft 28, which is designed as an output shaft 28 and is arranged coaxially to a second axis A2. The output shaft 28 is connected via an output gear set 30 to the power distribution unit 18, which is arranged coaxially to an axis A3.

A parking interlock gear can be fixed at the output shaft 28 or at an input element of the power distribution unit 18 in a rotationally fixed manner, by which the hybrid drive train 10 can be immobilized. The associated parking lock device is not represented, for the sake of clarity.

The transmission arrangement 16 has a first sub-transmission 32 and a second sub-transmission 34. The sub-transmissions 32, 34 are arranged axially offset with respect to each other. The first sub-transmission 32 is arranged adjacent to a first axial end of the transmission arrangement 16. The second sub-transmission 34 is arranged adjacent to a second axial end of the transmission arrangement 16, wherein the second axial end is adjacent to the dual-clutch assembly 14. The sub-transmissions 32, 34 have a plurality of engageable gear sets, which, in the engaged condition, connect an input shaft and the output shaft 28 in each case.

The first sub-transmission 32 has a first gear set 36 for the first forward gear step 1 and a second gear set 38 for the third forward gear step 3. The second gear set 38 is arranged closer to the second axial end of the transmission arrangement 16 than the first gear set 36. Moreover, the first sub-transmission 32 has a third gear set 42 for the fifth forward gear step 5. The third gear set 42 is arranged closer to the first axial end of the transmission arrangement than the first gear set 36.

A first gearshift clutch assembly 40 is arranged between the first gear set 36 and the third gear set 42 and, in fact, coaxially to the axis A2. The first gearshift clutch assembly 40 includes a first gearshift clutch A for engaging the first gear set 36 and a second gearshift clutch E for engaging the third gear set 42. The two gearshift clutches A, E are alternately engageable and are designed as non-synchronized dog clutches. The engagement of a gear set includes the rotationally fixed connection of an idler gear of the particular gear set to an associated shaft. In the present case, for example, the first gear set 36 is engaged, in that an idler gear of the first gear set 36, which is rotatably mounted at the output shaft 28, is rotationally fixed to the output shaft 28, in order to bring the first gear set into the power flow in this way.

The second gear set 38 is engageable by a gearshift clutch C and has an idler gear, which is rotatably mounted at the first input shaft 24.

The second sub-transmission 34 has a fourth gear set 48 for the second forward gear step 2 and a fifth gear set 50 for the fourth forward gear step 4. The fifth gear set 50 is arranged closer to the second axial end than the fourth gear set 48. A second gearshift clutch assembly 52 is arranged between the gear sets 48, 50 and, in fact, coaxially to the axis A2. The second gearshift clutch assembly 52 has a gearshift clutch B for engaging the fourth gear set 48 and a gearshift clutch D for engaging the fifth gear set 50. The gearshift clutches B and D are accommodated in the second gearshift clutch assembly 52 in such a way that the gearshift clutches B and D are alternately actuatable.

Consequently, the transmission arrangement 16 has five gear set planes, namely, starting from the second axial end toward the first axial end, in the following order: gear set 50 for the fourth forward gear step 4, gear set 48 for the second forward gear step 2, gear set 38 for the third forward gear step 3, gear set 36 for the first forward gear step 1, and gear set 42 for the fifth forward gear step 5.

Moreover, the hybrid drive train 10 includes a first electric machine 56, which is arranged coaxially to a fourth axis A4. The first electric machine 56 has a first pinion 58, which is rotationally fixed to a rotor of the first electric machine 56 and is coaxial to the axis A4. The first pinion 58, which can also be referred to as the first machine pinion, is connected to a gear-step gear set of the first sub-transmission 32, in the present case to the third gear set 42 for the fifth forward gear step 5, via a first intermediate gear 59, which is rotatably mounted at an axle (not described in greater detail). More precisely, the first pinion 58 meshes with the first intermediate gear 59, and the first intermediate gear 59 meshes with a fixed gear of the third gear set 42, wherein the fixed gear is rotationally fixed to the first input shaft 24.

Moreover, the hybrid drive train 10 has a second electric machine 60, which is arranged axially parallel to the input shafts 24, 26 and, in fact, coaxially to a fifth axis A5. The second electric machine 60 has a second pinion (second machine pinion) 62, which is arranged coaxially to the axis A5. The second pinion 62 is connected to the second input shaft 26 via a gear-step gear set of the second sub-transmission 34. In the present case, the second pinion 62 is connected to the fifth gear set for the fourth forward gear step 4 via a second intermediate gear 63. More precisely, the second pinion 62 meshes with the second intermediate gear 63, which is rotatably mounted at an axle (not described in greater detail), and the second intermediate gear 63 meshes with a fixed gear of the fifth gear set 50, wherein the fixed gear is rotationally fixed to the second input shaft 26.

The five axes A1, A2, A3, A4, A5 are all aligned in parallel with one another.

The dual-clutch assembly 14 is arranged adjacent to the second axial end of the transmission arrangement 16, as mentioned above. The output gear set 30 is also arranged on the second axial side of the transmission arrangement 16 and is preferably axially aligned with the dual-clutch assembly 14 or is situated approximately in a plane therewith. The parking interlock gear P can be fixed at the output shaft 28 between the output gear set 30 and the fifth gear set 50.

In the hybrid drive train 10, the electric machines 56, 60 are each connected to a gear-step gear set of an associated sub-transmission, which is associated with the highest gear step of that sub-transmission. Moreover, the electric machines 56, 60 are each connected via a gear-step gear set to the particular sub-transmission that is preferably arranged adjacent to an axial end of the transmission arrangement. The gear sets are situated at opposite axial ends.

The electric machines 56, 60 are arranged in axial overlap with each other. Due to the connection via intermediate gears 59, 63, high ratios for the particular gear-step gear sets can be established, and so electric machines 56, 60 rotating at relatively high speeds can be utilized, which are compact.

The hybrid transmission arrangement 16 in the present case has precisely five forward gear steps and does not have a reverse gear step. An operation in reverse can be exclusively established by the hybrid drive train 10 when one of the electric machines 56 or 60 is driven in the opposite direction of rotation.

The transmission arrangement 16 has no winding-path gear steps. Each gear set 36 through 50 includes precisely one idler gear and one fixed gear, wherein the idler gears of the gear sets 36, 42, 48, 50 are rotatably mounted at the output shaft 28, and wherein the idler gear of the gear set 38 is rotatably mounted at the first input shaft 24.

The dual-clutch assembly 14 and the two gearshift clutch assemblies 40, 52 and the gearshift clutch C are actuatable by four actuating units S1 through S4.

One actuating unit S1 is utilized for actuating the clutch K1 of the dual-clutch assembly 14 and can engage or disengage the clutch K1.

The first gearshift clutch assembly 40 can be actuated by a fourth actuating unit S4. By the fourth actuating unit S4, either the gearshift clutch A can be engaged, or the gearshift clutch E can be engaged, or a neutral position can be established.

In a corresponding way, the second gearshift clutch assembly 52 can be actuated by a third actuating unit S3, in order to either engage the clutch D, or engage the clutch B, or establish a neutral position.

Finally, by a second actuating unit S2, the second clutch K2 of the dual-clutch assembly 14 or the gearshift clutch C can be engaged. The second actuating unit S2 is coupled to the second clutch K2 of the dual-clutch assembly as well as to the gearshift clutch C of the first sub-transmission. The coupling is implemented in the manner of a gearshift clutch assembly in such a way that the second actuating unit S2 can also establish a neutral position, in which the second clutch K2 and the gearshift clutch C are both disengaged.

When a power transmission in the transmission arrangement 10 from FIG. 1 takes place via the first input shaft 24 and the first clutch K1 is engaged, the third actuating unit S3 is in a neutral position. In this case, each of the gearshift clutches A, E, C of the first sub-transmission can be alternately engaged. When the gearshift clutch C is engaged in order to establish the third forward gear step 3 in this operation, the second clutch K2 of the dual-clutch assembly 14 is disengaged. The second clutch K2 of the dual-clutch assembly 14 could also be engaged during the establishment of the third forward gear step 3 when the third actuating unit S3 is in the neutral position.

On the other hand, if power is to be transmitted via the second input shaft 26, the second clutch K2 is engaged by the second actuating unit S2 and the first clutch K1 is disengaged by the first actuating unit S1. Due to the engagement of the second clutch K2, the gearshift clutch C for the third forward gear step 3 is disengaged.

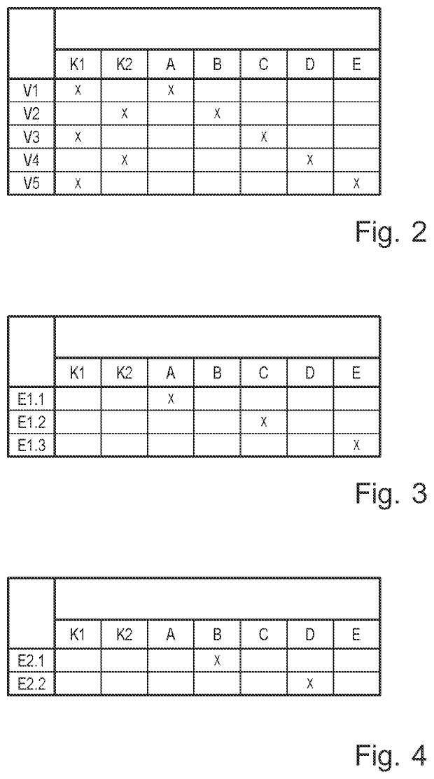

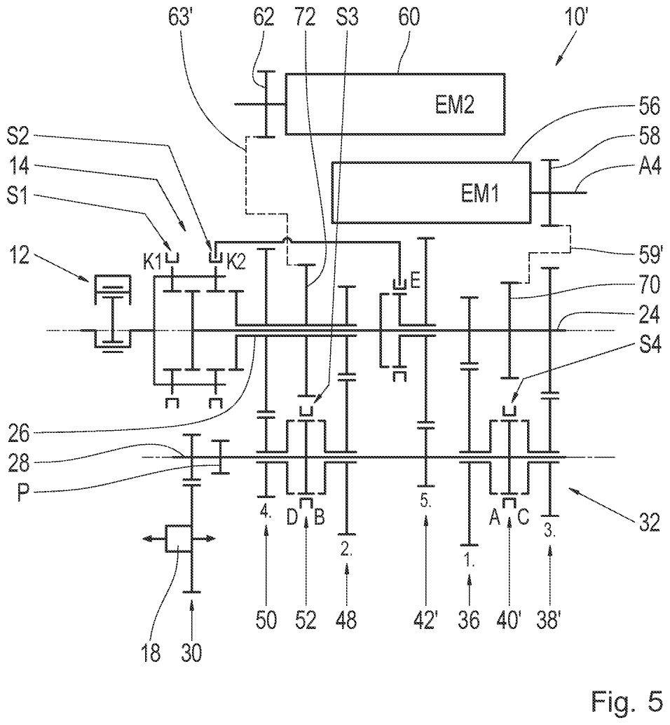

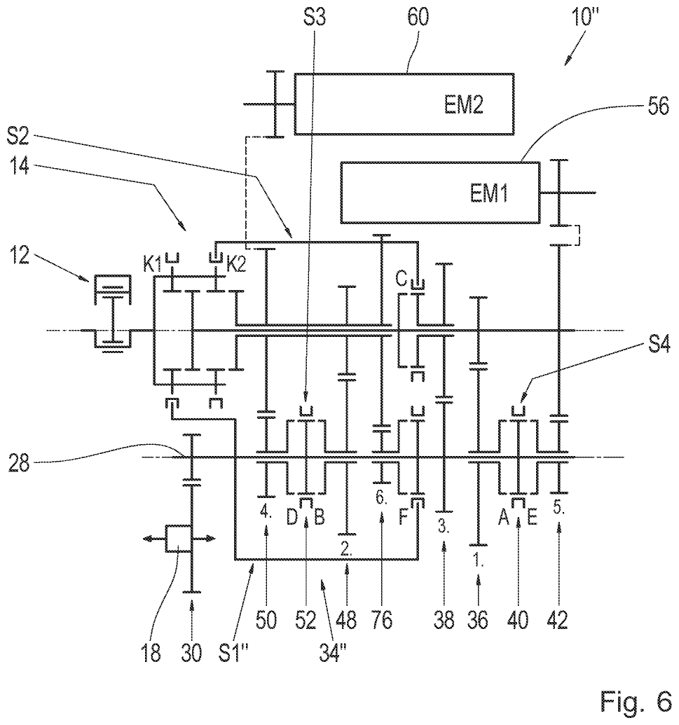

Different operations, which are establishable with the hybrid drive train 10 from FIG. 1, are explained with reference to FIGS. 2 through 4. The same operations are also usable with the hybrid drive trains 10′, 10″ from FIGS. 5 and 6, however.

FIG. 2 shows a gearshift table of the shift elements K1, K2, A-E in a purely internal combustion engine-driven operation or in a hybrid operation, in which input power is made available by the internal combustion engine and, optionally, by the electric motors 56, 60.

In all forward gear steps V1 through V5 establishable in this operation, the first clutch K1 or the second clutch K2 of the dual-clutch assembly 14 is alternately engaged. In the forward gear steps V1, V3, and V5, the first clutch K1 is engaged and the second clutch K2 is disengaged. In the forward gear steps V2 and V4, the second clutch K2 is engaged and the first clutch K1 is disengaged. In the forward gear step V1, the gearshift clutch A is additionally engaged and all other gearshift clutches B through E are disengaged. Consequently, power flows from the internal combustion engine via the first clutch K1 and the first input shaft 24 to the first gear set 36 and, from there, via the gearshift clutch A to the output shaft 28.

It is understood that a driving start from a standstill generally takes place purely by electric motors 56, 60 until a speed is reached, at which the internal combustion engine 12 can be connected via the first clutch K1, i.e., at a speed that corresponds to a rotational speed above the idling speed of the internal combustion engine 12. Consequently, a driving start from a standstill takes place, for example, via the first electric machine 56 and the first gear set 36 for the forward gear step V1. As soon as a speed has been reached that corresponds to the speed of the internal combustion engine 12, the first clutch K1 can be engaged.

During the changeover from the forward gear step V1 into the forward gear step V2, initially the gearshift clutch B for the forward gear step 2 is preliminarily engaged. This can take place, if necessary, with the aid of a synchronization by the second electric machine 60.

Thereafter, the gearshift clutch A for the forward gear step V1 and the first clutch K1 are disengaged, wherein the tractive force is supported by the second electric machine 60 and the already engaged gear set 48 for the forward gear step V2. Thereafter, the second clutch K2 can be engaged, wherein the synchronization necessary therefor takes place, on the one hand, by a rotational-speed adaptation of the internal combustion engine 12, but also by appropriate synchronization measures of the second electric machine 60. In the second forward gear step, power therefore flows from the internal combustion engine 12 via the second clutch K2, the second input shaft 26, and the gear set 48 for the second forward gear step V2 engaged by the gearshift clutch B, to the output shaft 28.

During the changeover into the forward gear step V3, due to the fact that the second clutch K2 and the gearshift clutch C for the forward gear step V3 are actuated via a single actuating unit S2, the following approach is preferred. In the forward gear step V2, the second clutch K2 is engaged, and the first clutch K1 is disengaged. Initially, tractive force is supported via the second electric machine 60 and the forward gear step V2. Thereafter, the second clutch K2 can be disengaged and the gearshift clutch C can be engaged, wherein the neutral position of the second actuating unit S2 is passed through. Thereafter, the first clutch K1 can be engaged, in order to apply the power to the third forward gear step V3, and the tractive force of the second electric machine 60 can be decreased. Finally, the second gearshift clutch B of the second forward gear step V2 can be disengaged.

The further gear changes from the gear steps V3 to V4 and from V4 to V5 result in a corresponding way.

In FIG. 3, a purely electric motor-driven operation by the first electric machine is represented. In a first electric gear step E1.1, only the gearshift clutch A for the forward gear step 1 is engaged. In a second electric forward gear step E1.2, only the gearshift clutch C is engaged. In a third electric-motor gear step E1.3, the gearshift clutch E is engaged.

In a corresponding way, FIG. 4 shows a purely electric motor-driven operation by the second electric machine 60. In a first gear step E2.1, only the gearshift clutch B is engaged. In a second electric gear step E2.2, only the gearshift clutch D is engaged.

In the purely electric operation according to FIGS. 3 and 4, purely electric powershifts (i.e., gear changes between forward gear steps without or with reduced interruption of tractive force) are possible. Here, an electric motor-driven operation is established exclusively, for example, between the gear steps E1.1, E1.2, E1.3 or exclusively between the gear steps E2.1 and E2.2, and a gear change takes place while the other electric machine maintains the tractive force.

During a gear change, for example, from the forward gear step E1.1 into the forward gear step E1.2, the gearshift clutch B can be engaged in the second sub-transmission 34 and, consequently, the second electric machine 60 can maintain the tractive force during the gear change in the first sub-transmission 32.

A changeover of the two clutches K1, K2 of the dual-clutch assembly 14 preferably always takes place in such a way that at least one of the two clutches K1, K2 is always engaged. This means, both clutches K1, K2 are simultaneously engaged during the changeover.

For example, during a changeover from clutch K1 to clutch K2, the clutch K2 is initially engaged in addition to clutch K1 and, thereafter, clutch K1 is disengaged. The clutch K2 is synchronized with the second electric machine 60.

During a changeover from clutch K2 to clutch K1, the first clutch K1 is initially engaged in addition to clutch K2 and, thereafter, the second clutch K2 is disengaged. The first clutch K1 is synchronized with the first electric machine 56.

In other words, the two clutches K1 and K2 can always be synchronized with the aid of an electric machine.

During powershifts in the hybrid mode, by utilizing the internal combustion engine 12, there are two possibilities for switching from one gear (actual gear) of the first sub-transmission 32 into a gear (target gear) of the second sub-transmission 34. In one example variant, the first electric machine 56 supports the gear shift in the actual gear. This method is possible in the case of the actual gears 1 and 5, but not in the case of the actual gear 3, since the gearshift clutch C is actuated together with the second clutch K2.

Alternatively, it is possible to support the gear shift from the first sub-transmission 32 onto the second sub-transmission 34 via the second electric machine 60 in the target gear. This method is also possible in the case of the actual gear 3.

On the other hand, gear shifts from the second sub-transmission 34 into the first sub-transmission 32 can take place, in general, when the second electric machine 60 supports the tractive force in the actual gear during the gear shift.

In general, it is also conceivable to support the tractive force during the gear shift by the first electric machine 56 in the target gear. This method is possible in the case of the target gears 1 and 5, however, but not in the case of the target gear 3, for the aforementioned reason.

When travel takes place by the internal combustion engine 12 via the first clutch K1 in a gear of the first sub-transmission 32, the second electric machine 60 can be decoupled, in order to avoid drag losses. The first electric machine 56 preferably remains coupled, in order to supply a main power circuit with electrical energy and, thereby, the first electric machine 56 can additionally drive (“boost”). This is particularly important in the fifth gear (since the fifth gear is utilized for a longer time during expressway travel).

In a corresponding way, during an internal combustion engine-driven operation via the second sub-transmission 34, the first electric machine 56 can be decoupled, but the second electric machine 60 can remain coupled.

When the clutches K1 and K2 are simultaneously engaged, the internal combustion engine 12 as well as the two electric machines 56, 60 can jointly drive the first sub-transmission 32 via the first gear and the fifth gear. If recuperation takes place in the case of a deceleration, the internal combustion engine 12 and the second electric machine 60 can be decoupled by disengaging the first clutch K1. Recuperation then takes place in the actual gear of the first electric machine 56. The internal combustion engine 12 and the second electric machine 60 remain connected. If the internal combustion engine 12 is switched off, a restart can quickly take place by the second electric machine 60. Alternatively, the second electric machine 60 can also operate as a generator in this case (the internal combustion engine 12 continues to run). A coupling to the drive train 10 by engaging the first clutch K1 is quickly possible.

This operating mode is generally not possible for the third forward gear step due to the common actuating unit S2.

On the other hand, when the two clutches K1 and K2 are simultaneously engaged, the internal combustion engine 12, the first electric machine 56, and the second electric machine 60 can jointly drive via the second gear and the fourth gear of the second sub-transmission 34. If recuperation takes place in the case of a deceleration, the internal combustion engine 12 and the first electric machine 56 can be decoupled by disengaging the second clutch K2. The further possibilities are identical to the case in which driving takes place jointly via the first sub-transmission 32.

It is understood that stationary charging is possible and, in fact, by engaging, for example, the first clutch K1, in order to connect the first electric machine 56 to the internal combustion engine 12, without a force-fit connection to the output shaft 28 being established (i.e., the transmission arrangement 16 is then in neutral and all gearshift clutches A through E are disengaged). In this condition, the internal combustion engine 12 can be started with the first electric machine 56 and a supply of the main power circuit can take place by operating the first electric machine 56 as a generator and/or a charging of an electrical energy accumulator can take place.

The same operation is also possible in a corresponding way by engaging the second clutch K1.

The two clutches K1 and K2 can also be simultaneously engaged, in order to enable a generator mode with both electric machines 56, 60.

The two electric machines 56, 60 preferably have identical dimensions.

The second clutch K2 can be engaged when a serial operation is established. Here, the first clutch K1 is disengaged. Via the first sub-transmission 32 and the first electric machine 56, a purely electric motor-driven operation is established in a gear step, for example, in the forward gear step 1. The internal combustion engine 12 drives the second electric machine 60 via the engaged second clutch K2 and drives the second electric machine 60 as a generator, and so the power withdrawn from a vehicle battery by the first electric machine 56 in this purely electric operation can be simultaneously resupplied, at least partially, via the second electric machine 60.

A serial operation of this type is also possible in reverse when travel takes place purely electrically by the second electric machine 60 and the internal combustion engine 12 drives the first electric machine 56. In the latter case, the first clutch K1 is engaged and the second clutch K2 is disengaged.

The serial operation is utilized, in particular, in a crawling mode, in which the vehicle speed is lower than a minimum speed that is establishable by the internal combustion engine 12.

In FIG. 5, a further example embodiment of a hybrid drive train 10′ is represented, which generally corresponds to the drive train 10 from FIG. 1 with respect to configuration and mode of operation. Identical elements are therefore labeled with identical reference characters. In the following, essentially, the differences are explained.

It is apparent, on the one hand, that the gear sets for the third and fifth forward gear steps 3 and 5 are interchanged in the first sub-transmission 32. Consequently, the second gear set 38′ for the third forward gear step 3 is arranged closer to the first axial end of the transmission arrangement 16 than the third gear set 42′ for the fifth forward gear step 5. A gearshift clutch E for the fifth forward gear step 5 is arranged between the gear sets 42′ and 48, at the point, at which the gearshift clutch C is arranged in the drive train 10 from FIG. 1.

Moreover, the first gearshift clutch assembly 40′ contains the gearshift clutch A for engaging the first gear set 36 for the first forward gear step 1 and the gearshift clutch C for engaging the second gear set 38′ for the third forward gear step 3.

As represented in FIG. 5, moreover, the first electric machine 56 and/or the second electric machine 60 do/does not necessarily need to be connected via a gear-step gear set to the particular associated input shaft 24, 26. Rather, it is also possible to fix a first gearwheel (first machine gearwheel) 70 at the first output shaft 24, which is in engagement with the first pinion 58 directly or via a first intermediate gear 59′.

In a corresponding way, a second gearwheel (second machine gearwheel) 72 can be fixed at the second output shaft 26, which is in engagement with the second pinion 62 directly or via a second intermediate gear 63′.

Due to the first gearwheel 70 and/or the second gearwheel 72, one additional degree of freedom can be implemented, which simplifies the implementation of the pre-ratio.

The first gearwheel 70 is preferably situated in a plane with the first gearshift clutch assembly 40′, and so this implementation is possible in a length-neutral manner. In the same way, the second gearwheel 72 is axially aligned with the second gearshift clutch assembly 52, and so the provision of the second gearwheel 72 also does not result in a lengthening of the installation space.

In particular for the case in which the gearwheels 70, 72 are not provided, but rather a connection is to take place via the gear sets that are arranged at the axial ends of the transmission arrangement 16, the following advantage can be achieved. This is the case because the first electric machine 56, as shown in FIG. 1, can be connected to the first input shaft 24 via the gear-step gear set 42 that represents the highest ratio of the first sub-transmission 32, and so a larger ratio can be implemented in the electric operation.

The latter-described example variant is considered to be particularly preferred.

In FIG. 6, a further alternative example embodiment of a hybrid drive train 10″ is shown, which generally corresponds to the drive train 10 from FIG. 1 with respect to configuration and mode of operation. Identical elements are therefore labeled with identical reference characters. In the following, essentially, the differences are explained.

The second sub-transmission 34″ includes a further gear set 76 for a sixth forward gear step 6, which is arranged in the axial direction between the gear set 48 for the forward gear step 2 and the gearshift clutch plane with the gearshift clutch C. Moreover, the second sub-transmission 34″ includes a gearshift clutch F arranged at the output shaft 28, which is situated in the same gearshift clutch plane as the gearshift clutch C. The gearshift clutch F is associated with the gear set 76 for the forward gear step 6.

Due to this addition of a further gear set for the forward gear step 6 to the second sub-transmission 34″, the spread of gear ratios of the transmission arrangement 16 can be further increased.

Moreover, it is possible to still provide only four actuating units for actuating the drive train. These are the actuating unit S2 for the clutches K2 and C, the actuating unit S3 for the gearshift clutch assembly 52 with the gearshift clutches D and B, and the actuating unit S4 for the gearshift clutch assembly 40 with the gearshift clutches A and

E.

Moreover, an actuating unit S1″ is provided, which, similarly to the actuating unit S2, is associated with two clutches, namely the first clutch K1 of the dual-clutch assembly 14 and the gearshift clutch F for the sixth forward gear step 6.

It is understood that the sixth forward gear step 6 (V6) is established, in that the clutch K2 is engaged (which automatically results in an engagement of the gearshift clutch C).

The gearshift clutch F is engaged, in order to place the gear set 76 into the power flow. This takes place by the actuating unit S1″ and results in the first clutch K1 also being engaged.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 hybrid drive train
12 internal combustion engine
14 dual-clutch assembly
16 hybrid transmission arrangement
18 power distribution unit
20 driven wheels
22 control device
24 first input shaft
26 second input shaft
28 output shaft
30 output gear set
32 first sub-transmission
34 second sub-transmission
36 1st gear set (1)
38 2nd gear set (3)
40 first gearshift clutch assembly
42 3rd gear set (5)
48 4th gear set (2)
50 5th gear set (4)
52 second gearshift clutch assembly
56 first electric machine
58 first pinion (first machine pinion)
59 first intermediate gear
60 second electric machine
62 second pinion (second machine pinion)
63 second intermediate gear
66 third gearshift clutch assembly
70 first gearwheel (first machine gearwheel)
72 second gearwheel (second machine gearwheel)
76 gear set (6)
A1-A5 axes
A-E, F gearshift clutches for gear steps
K1, K2 clutches of dual-clutch assembly
EG input element
AG1 first output element
AG2 second output element
S1-S4 actuating units
P parking interlock gear

1-12: (canceled)

13. A drive train (10) for a motor vehicle, comprising:
a dual-clutch assembly (14) with a first clutch (K1) and a second clutch (K2), the first and second clutches (K1, K2) having a shared input element (EG) connectable to an internal combustion engine (12), the first clutch (K1) comprising a first output element (AG1), the second clutch (K2) comprising a second output element (AG2), a first actuating unit (S1) associated with the first clutch (K1), a second actuating unit (S2) associated with the second clutch (K2); and
a transmission arrangement (16) with a first sub-transmission (32) and a second sub-transmission (34), an input shaft (24) of the first sub-transmission (32) connected to the first output element (AG1), an input shaft (26) of the second sub-transmission (34) connected to the second output element (AG2),
wherein one or both of
the second actuating unit (S2) is associated with the second clutch (K2) of the dual-clutch assembly (14) as well as a gearshift clutch (C; E) of the first sub-transmission (32), and
the first actuating unit (S1″) is associated with the first clutch (K1) of the dual-clutch assembly (14) as well as a gearshift clutch (F) of the second sub-transmission (34).

14. The drive train of claim 13, further comprising one or both of:
a first electric machine (56) connected to the first input shaft (24); and
a second electric machine (60) connected to the second input shaft (26).

15. The drive train of claim 13, wherein one or more of the first clutch (K1) of the dual-clutch assembly (14), the second clutch (K2) of the dual-clutch assembly (14), and at least one gearshift clutch (A;B;C;D;E) of the transmission arrangement (16) is a dog clutch.

16. The drive train of claim 14, wherein one or both of:
the first electric machine (56) is connected to the first input shaft (24) via a gear-step gear set (42; 38″) of the first sub-transmission (32); and
the second electric machine (60) is connected to the second input shaft (26) via a gear-step gear set (50) of the second sub-transmission (34).

17. The drive train of claim 16, wherein one or both of:
the gear-step gear set (42) of the first sub-transmission (32) is associated with a highest gear step (5) of the first sub-transmission (32); and
the gear-step gear set (50) of the second sub-transmission (34) is associated with a highest or a second-highest gear step (4) of the second sub-transmission (34).

18. The drive train of claim 16, wherein one or both of:
the gear-step gear set (42; 38′) of the first sub-transmission (32) is arranged at a first axial end of the transmission arrangement (16); and
the gear-step gear set (50) of the second sub-transmission (34) is arranged at a second axial end of the transmission arrangement (16).

19. The drive train of claim 13, wherein one or both of:
the first sub-transmission (32) is associated with odd forward gear steps and has three gear sets (36, 38, 2), each of which is associated with a respective one of the odd forward gear steps (1, 3, 5); and
the second sub-transmission (34) is associated with even forward gear steps and has two or three gear sets (48, 50; 48, 50, 76), each of which is associated with a respective one of the even forward gear steps (2, 4; 2, 4, 6).

20. The drive train of claim 14, wherein the first electric machine (56) and the second electric machine (60) are identical.

21. The drive train of claim 13, wherein a coupling of the actuating unit to one of the first and second clutches (K2; K1) of the dual-clutch assembly (14) to the respective one of the gearshift clutches (C; E; F) of the first and second sub-transmissions (34; 32) is configured such that either:
the respective one of the gearshift clutches (C; E; F) of the first and second sub-transmissions (34; 32) is engaged; or
the one of the first and second clutches (K2; K1) of the dual-clutch assembly (14) is engaged; or
a neutral position is established, in which both the respective one of the gearshift clutches (C; E; F) of the first and second sub-transmissions (34; 32) and the one of the first and second clutches (K2; K1) of the dual-clutch assembly (14) are disengaged.

22. A method for operating the drive train (10) of claim 13, comprising:
operating in a condition with one of the first and second clutches (K1, K2) engaged, the other of the first and second clutches (K1, K2) disengaged, and input power is transmitted via the engaged one of the first and second clutches (K1, K2);
disengaging all gearshift clutches of the one of the first and second sub-transmissions (34) associated with the other of the first and second clutches (K1, K2), if necessary;
synchronizing a rotational speed of the input shaft (26) associated with the other of the first and second clutches (K1, K2) with the one of the first and second electric machines (60) associated with the other of the first and second clutches (K1, K2); and
engaging the other of the first and second clutches (K1, K2).

23. The method of claim 22, further comprising:
after engaging the other of the first and second clutches (K1, K2), disengaging the one of the first and second clutches (K1, K2); and
engaging a gearshift clutch (B; D) in the one of the first and second sub-transmission (34) associated with the other of the first and second clutches (K1, K2),
wherein one or both of
the engagement of the gearshift clutch (B; D) in the one of the first and second sub-transmission (34) associated with the other of the first and second clutches (K1, K2) is supported by a respective one of a first and second electric machines (56) associated with the one of the first and second clutches (K1, K2), and
before the engagement of the gearshift clutch (B; D) in the one of the first and second sub-transmission (34) associated with the other of the first and second clutches (K1, K2), the gearshift clutch (B; D) in the one of the first and second sub-transmission (34) associated with the other of the first and second clutches (K1, K2) is synchronized by the other one of the first and second electric machines (60) associated with the other of the first and second clutches (K1, K2).

24. A method for operating the drive train (10) of claim 13, comprising:
in a purely electric motor-driven operation, providing input power of a first electric machine (56) via the first sub-transmission (32) and simultaneously providing input power of a second electric machine (60) via the second sub-transmission (34); and
implementing a powershift such that one of the first and second electric machines (56, 60) maintains tractive force via the respective one of the first and second sub-transmissions (32, 34) while a gear change is carried out in the other one of the first and second sub-transmissions (32, 34).
